(19) United States
(12) Patent Application Publication
(10) Pub. No.: US 2026/0141201 A1
(43) Pub. Date: May 21, 2026

(54) MINIMIZING PRINTHEAD DIFFERENTIAL AND METHODS THEREOF

(71) Applicant: XEROX CORPORATION, NORWALK, CT (US)

(72) Inventors: Christine A. STEURRYS, Williamson, NY (US); Jason M. LeFEVRE, Penfield, NY (US); Seemit PRAHARAJ, Webster, NY (US); Mark C. PETROPOULOS, Webster, NY (US); Peter M. GULVIN, Webster, NY (US); Varun SAMBHY, Pittsford, NY (US); Anthony S. CONDELLO, Webster, NY (US); Nicholas David STUCCHI, Rochester, NY (US); Douglas K. HERRMANN, Webster, NY (US)

(73) Assignee: XEROX CORPORATION, NORWALK, CT (US)

(21) Appl. No.: 18/953,685

(22) Filed: Nov. 20, 2024

(51) Int. Cl. G06K 15/02; B41J 2/21

(52) U.S. Cl. CPC G06K 15/027; B41J 2/2103; B41J 2/2128; B41J 2/2135; B41J 2/2146; G06K 2215/101

(57) ABSTRACT

A system and method for minimizing printhead density differences is disclosed, which includes printing a first test patch onto a first print at one or more halftone levels using a print head array may include more than one print head, scanning the first test patch, calculating an average print density of the first test patch for each print head and an average print density for the print head array, adjusting a drive voltage for each print head to match the average print density of the first test patch for the print head array, printing a second test patch onto a second print at one or more halftone levels using the print head array, scanning the second test patch. The method includes calculating an average print density of the second test patch for each print head and an average print density for the print head array.

### TECHNICAL FIELD

The present teachings relate generally to ink jet printing systems and, more particularly, to methods of reducing printhead differential in ink jet printing systems.

### BACKGROUND

Production ink jet printers typically interlace, or stitch, multiple print heads together to enable the printing of wide paper in one pass through the ink jet printer. In examples ink jet printing production systems, three or more print heads are used to achieve a print width of at least fourteen inches. While print heads are calibrated in manufacturing to a specific drop mass target, there is enough print head to print head variation to visually observe a difference in image density in the production printer.

Methods exist to adjust the average print density of each print head. These methods are sufficient to remove a significant portion of the print head to print head variation, however, when a density variation exists within a single print head, the edge of one print head may have a different density than the edge of the neighboring print head. This can result in a sudden, visible shift of print density in the print which is more visible than a gradual shift in print density of the same magnitude. In some instances, a density optimization algorithm can be used to smooth these density variations, but the change in the stitch zone region is sometimes too large for complete compensation.

Therefore, it is desirable to provide methods to compensate for these visible differences to reduce these shifts in print density.

### SUMMARY

The following presents a simplified summary in order to provide a basic understanding of some aspects of one or more embodiments of the present teachings. This summary is not an extensive overview, nor is it intended to identify key or critical elements of the present teachings, nor to delineate the scope of the disclosure. Rather, its primary purpose is merely to present one or more concepts in simplified form as a prelude to the detailed description presented later.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. A method for minimizing printhead density differences is disclosed. The method includes printing a first test patch onto a first print at one or more halftone levels using a print head array may include more than one print head, scanning the first test patch, calculating an average print density of the first test patch for each print head and an average print density for the print head array, adjusting a drive voltage for each print head to match the average print density of the first test patch for the print head array, printing a second test patch onto a second print at one or more halftone levels using the print head array, scanning the second test patch. The method also includes calculating an average print density of the second test patch for each print head and an average print density for the print head array, and where the method also includes the first test patch and the second test patch are printed by all print heads in the print head array.

Implementations of the method for minimizing printhead density differences include where the average print density of the first test patch and the second test patch are calculated at an edge of each print head. The method for minimizing printhead density differences may include adjusting a drive voltage for each print head to match the average print density of the second test patch for the print head array. The one or more halftone levels for the first test patch and the second test patch are printed with a common pigmented ink. Printing the first test patch and printing the second test patch is done using all available jets in the print head array. The print head array may include three print heads. Adjusting a drive voltage for each print head further may include: adjusting a drive voltage of a left print head such that a density of a right edge of the left print head matches a left edge of a neighboring print head, and adjusting a drive voltage of a right print head such that a density of a left edge of the left print head matches a right edge of the neighboring print head. An inner edge has the same average density as the mating edge of the neighboring print head. The method for minimizing printhead density differences may include repeating adjusting a drive voltage for each print head until a difference between an edge of each print head is visually imperceptible.

A method for minimizing stitch zone differential between adjacent print heads in a production ink jet system is disclosed. The method also printing a first test patch onto a first print at one or more halftone levels using a print head array may include a first print head and a second print head, scanning the first test patch, calculating an average density of jets near a mating edge of the first print head and a mating edge of the second print head, and adjusting a drive voltage for the first print head to move an average print density of the first print head at the mating edge of the first print head towards an average print density of the mating edge of the second print head. Implementations of the method for minimizing stitch zone differential between adjacent print heads in a production ink jet system include where the print head array further may include a third print head. The method for minimizing stitch zone differential between adjacent print heads in a production ink jet system may include the steps of printing the first test patch using the third print head, calculating an average density of jets near a mating edge of the third print head and a second mating edge of the second print head, and adjusting a drive voltage for the third print head to move the average print density of the third print head at the mating edge of the third print head towards an average print density of the second mating edge of the second print head. The method for minimizing stitch zone differential between adjacent print heads in a production ink jet system may include executing a print density optimization algorithm to reduce remaining density variations across an entire process width of the print head array. The method for minimizing stitch zone differential between adjacent print heads in a production ink jet system may include repeating adjusting drive voltages until a difference between the average print density of the first print head at the mating edge of the first print head and an average print density of the mating edge of the second print head is visually imperceptible. The method for minimizing stitch zone differential between adjacent print heads in a production ink jet system can include an aspect of where the adjusting the drive voltage is made based on paper type or printing conditions. The one or more halftone levels for the first test patch is printed with black pigmented ink. The one or more halftone levels for the first test patch is printed with a color other than black pigmented ink.

A printing system for minimizing stitch zone differentials between adjacent print heads in a production ink jet printer is disclosed. The printing system includes at least three print heads arranged in an array configured to print aqueous ink in an interlaced manner and form a single pass of printed image. The system also includes a scanner configured for measuring an average print density of each print head near a stitching area of each print head. The system also includes a non-transitory storage media configured to execute an algorithm that adjusts drive voltages based on measurements of the scanner to minimize stitch zone differentials between adjacent print heads. Implementations of the printing system for minimizing stitch zone differentials between adjacent print heads in a production ink jet printer may include a sensor array configured to monitor print density during printing and where adjusting drive voltages occurs prior to jetting ink from one of the print heads. The algorithm adjusts drive voltages based on a statistical distribution of measured print density.

The features, functions, and advantages that have been discussed can be achieved independently in various implementations or can be combined in yet other implementations further details of which can be seen with reference to the following description.

### BRIEF DESCRIPTION OF THE DRAWINGS

The accompanying drawings, which are incorporated in and constitute a part of this specification, illustrate embodiments of the present teachings and together with the description, serve to explain the principles of the disclosure. In the figures:

FIG. 1 is a schematic diagram of a system and method for minimizing printhead density differences in ink jet printing, in accordance with the present disclosure

FIGS. 2A and 2B are a schematic of a print head array layout with a stitch zone, and a top view of a printed patch from a similar print head array, in accordance with the present disclosure.

FIGS. 3A-3D are plots demonstrating the results of a method for minimizing printhead density differences in a printing system, in accordance with the present disclosure.

FIG. 4 is a flowchart illustrating a method for minimizing printhead density differences in a printing system, in accordance with the present disclosure.

It should be noted that some details of the figures have been simplified and are drawn to facilitate understanding of the present teachings rather than to maintain strict structural accuracy, detail, and scale.

### DETAILED DESCRIPTION

Reference will now be made in detail to exemplary embodiments of the present teachings, examples of which are illustrated in the accompanying drawings. Wherever possible, the same reference numbers will be used throughout the drawings to refer to the same, similar, or like parts.

The present disclosure provides a method for minimizing printhead density differences, including printing a first, full width test patch onto a first print at one or more halftone levels using a print head array comprising more than one print head, scanning the first full width test patch, calculating an average print density of the test patch for each print head of the array and an average print density for the print head array, adjusting a drive voltage for each print head to match the average print density of the first test patch for the print head array, printing a second test patch onto a second print at one or more halftone levels using the print head array, scanning the second test patch, and calculating an average print density of the second test patch for each print head and an average print density for the print head array. This method can be conducted iteratively until the average print density at each mating edge of each print head is within a certain range, such that a visual stitching or difference between print heads at the mating edge is visually indistinguishable. The halftone test patches can be printed using black ink, process black ink, one or more colors, or a combination thereof.

For a general understanding of the environment for the printer and the printer operational method disclosed herein as well as the details for the printer and the printer operational method, reference is made to the drawings. In the drawings, like reference numerals have been used throughout to designate like elements. As used herein, the word “printer” encompasses any apparatus that ejects ink drops onto different types of media to form ink images.

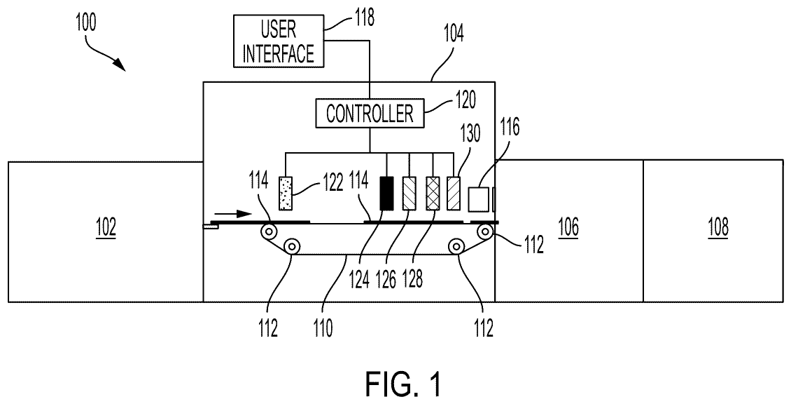

FIG. 1 is a schematic diagram of a system and method for minimizing printhead density differences, in accordance with the present disclosure. The system and a method for minimizing printhead density differences can be integrated in entirety, or in part, into a high-speed color inkjet printer 100. The system and method of the present disclosure includes a method of preventing visible differences across print head arrays including multiple print heads. FIG. 1 depicts a high-speed color inkjet printer 100 that uses a method in conjunction with full width printing to minimize stitching differential or visually issues between multiple print heads in a full width print head array. As illustrated, the printer 100 is a printer that directly forms an ink image on a surface of a media sheet stripped from one of the supplies of media sheets stored within a paper feeder 102 and the sheets are moved through the printer 100 in a process direction by a controller 120 operating one or more of the actuators that are operatively connected to rollers or to at least one driving roller of conveyor that comprise a portion of the media transport 110 that passes through the print engine module 104 of the printer. In one example, each printhead module has more than one printhead that form an array having a width that corresponds to a width of the widest media in the cross-process direction that can be printed by the printer. In such examples, the printhead modules have a plurality of printheads with each printhead having a width that is less than a width of the widest media in the cross-process direction that the printer can print. In these modules, the printheads are arranged in an array of staggered printheads or a linear array of printheads that abut one another to enable media wider than a single printhead to be printed. Additionally, the printheads within a module or between modules can also be interlaced so the density of the drops ejected by the printheads in the cross-process direction can be greater than the smallest spacing between the inkjets in a printhead in the cross-process direction. Although printer 100 is depicted with only two supplies of media sheets, the printer can be configured with three or more sheet supplies, each containing a different type or size of media. In exemplary printing systems, most jets on a print head are at a 1200 dpi (dots per inch) spacing. There is a region of jets on the edge of each print head with an increased jet spacing (900 dpi, then 600 dpi, then 300 dpi), such that when the two print heads are aligned properly and a left edge of one print head is printed to overlap the right edge of the neighboring print head, the 1200 dpi spacing is formed. The area of overlap is referred to as the stitch zone.

With further reference to FIG. 1, the printed image exits the print engine module 104 having a print zone of printer 100 and passes under one or more image dryers 106 after the ink image is printed on a sheet, represented herein as a more generic media 114. As used in this document, the term “print zone” means an area of a media transport opposite the printheads of an inkjet printer. The image dryer 106 can include an infrared heater, a heated air blower, air returns, or combinations of these components to heat the ink image and at least partially fix an ink image to the sheet. An infrared heater applies infrared heat to the printed image on the surface of the sheet to evaporate water or solvent in the ink. The heated air blower directs heated air using a fan or other pressurized source of air over the ink to supplement the evaporation of the water or solvent from the ink. The air is then collected and evacuated by air returns to reduce the interference of the dryer air flow with other components in the printer. In normal printing operations, the media 114 or sheet is jetted upon with ink or primer or precoat solution in an imagewise fashion and transported through the print zone to create a multicolor image. It should be noted that primer application is an optional feature in printing systems. The application of primer may not be integrated into all ink jet printing systems. This methods of the present disclosure are not necessarily applicable to primer or precoat application, since those fluids are generally clear or colorless and thus do not produce a measurable density. Prior to reaching the print zone, the media 114 passes beneath a primer application module 122. The primer application module 122 includes one or more printheads configured as described previously. In the implementation shown, there are four ink jetting printheads, but other systems may include more or less ink jetting printheads. These printheads are capable of ejecting drops of primer or pre-coat solution onto the media prior to the media being printed by the printhead modules 124, 126, 128, and 130. In some examples, the location and presence of primer applied to the media 114 is measured by a detector or scanner 116. It should be noted that in examples, one or more of the printhead stations, including the primer, may or may not occur in any particular sequence, depending on the stage within the diagnostic method of the present disclosure. In examples, the detector can be inline and positioned within the printing system 100 or can be external to the printer 100, such that a diagnostic sheet can be evaluated offline. The signal generated by the detector can be a visual signal, perceptible by an operator, or provided to the controller 120 via an inline scanner 116, image analysis or detector. In examples, the scanner 116 measures print density of one or more locations of the printed image. The controller 120 is configured with programmed instructions stored in non-transitory, computer readable media that when executed cause the controller to identify or capture one or more attributes related to the environmental conditions of the printer and surrounding environment, paper conditions or attributes, the amount and thickness of primer on the media and can make adjustments to the drive voltage, or other operational parameters of one or more jets or one or more print heads to correct or modify the appearance or performance or parameter of one or more settings or operating conditions to improve printing conditions or results, such as but not limited to a differential between one or more print heads in a mating edge on or between multiple print heads arranged in a print head array, or indicate a need for a manual operation or intervention by a machine operator.

In examples of a printer 100 as shown and described herein, a return path for printing duplex, or two-sided images can be employed, as well as an accompanying duplex path and controller instructions as needed. FIG. 1 also shows the printed sheets as being collected in the output module 108, but in examples, they can be directed to other processing stations (not shown) that perform tasks such as folding, collating, binding, and stapling of the media sheets.

Operation and control of the various subsystems, components and functions of the machine or printer 100 are performed with the aid of a controller or electronic subsystem (ESS) 120. The ESS or controller 120 is operatively connected to the components of the printhead modules 122, 124, 126, 128, and 130 (and thus the printheads), the detector, the image dryer 106, output module 108 and other system components not necessarily shown herein for purposes of clarity. The ESS or controller 120, for example, is a self-contained computer having a central processor unit (CPU) with electronic data storage, and a display or user interface (UI) 118. The ESS or controller 120, for example, includes a sensor input and control circuit as well as a pixel placement and control circuit. In addition, the controller 120 reads, captures, prepares, and manages the image data flow between image input sources, such as a scanning system or an online or a work station connection (not shown), and the printhead modules 122, 124, 126, 128, and 130. As such, the ESS or controller 120 is the main multi-tasking processor for operating and controlling all of the other machine subsystems and functions, including the printing process.

The controller 120 can be implemented with general or specialized programmable processors that execute programmed instructions. The instructions and data required to perform the programmed functions can be stored in non-transitory, computer readable medium associated with the processors or controllers. The processors, their memories, and interface circuitry configure the controllers to perform the operations described below when the programmed instructions are executed. These components can be provided on a printed circuit card or provided as a circuit in an application specific integrated circuit (ASIC). Each of the circuits can be implemented with a separate processor or multiple circuits can be implemented on the same processor. Alternatively, the circuits can be implemented with discrete components or circuits provided in very large scale integrated (VLSI) circuits. Also, the circuits described herein can be implemented with a combination of processors, ASICs, discrete components, or VLSI circuits.

In operation, image content data for an image to be produced are sent to the controller 120 from either a scanning system or an online or work station connection for processing and generation of the printhead control signals output to the printhead modules 122, 124, 126, 128, and 130. Along with the image content data, the controller receives print job parameters that identify the media weight, media dimensions, print speed, media type, ink area coverage to be produced on each side of each sheet, location of the image to be produced on each side of each sheet, media color, media fiber orientation for fibrous media, print zone temperature and humidity, media moisture content, and media manufacturer. As used in this document, the term “print job parameters” means non-image content data for a print job and the term “image content data” means digital data that identifies an ink image to be printed on a media sheet.

The inline scanner 116 can capture an image of the top surface of the print media, allowing for the detection of any missing jets, print density, or other defects in the printing system. Any scanner that can capture high-resolution images of the print media surface can be used for this purpose. The dryer is used for drying solid patches of ink on the first surface of the print media, including methods for drying the ink droplets using heat or UV light to evaporate the solvent in the ink.

The method can involve comparing one or more areas of print density, at a margin or mating edge between one or more print heads in a full width print head array. The mating edge between printheads can be defined as the zones where two print heads meet, including the jets that are located at that edge where two print heads meet. The range of that mating edge, mating zone, or mating region is from about 20 jets to about 200 jets, or from about 40 to about 150 jets or from about 40 to about 55 jets. For example, in some print heads, the first 1200 dpi jet is jet number 56. The edge overlap is (2*55)/1200 dpi=0.09 inches, or 2.3 mm. For purposes of this disclosure, the density of these 55 jets on each print head is not measured because it is impossible to measure it independent of the neighboring print head due to the overlap at the edge. The jets beginning with the 56^{th} from each end are measured. Once a test pattern is printed, the center head, or neighboring head, or in the case of more than three heads being in a printhead array, one of the center-most heads is selected as the standard performing head. In examples, a sudden density shift can become visible above 0.5 dE (delta E or ΔE) CIE. If the density shift is less sudden a specification of 1.0 dE CIE may be used. Therefore, a difference of from about 0.25 dE to about 1.5 dE, or from about 0.5 dE to about 1.0 dE could be the range of visible density in a test print or print in normal operation.

Visual inspection, color filters or light sources, and evaluation of delta L* value or color density can be employed for this purpose of quantification of print density. Delta L* is a component of a color space standard, the LAB color model, which can be used for color management and colorimetry. The LAB color model is a device-independent color model capable of representing all colors visible to the human eye. The LAB color model is based on the CIE (Commission Internationale de l'Eclairage) color space, and it defines colors in terms of lightness (L), position between red and green (a), and position between yellow and blue (b). The CIE L*a*b* color scale can be used in the present disclosure to quantify the color values of inks or visible jetted print materials. L is an indication of the gray scale where 0 is black and 100 is white, a is an indication of the red (positive values)—green (negative values) color scale and b is an indication of the yellow (positive values)—blue (negative values) color scale.

The use of an inline scanner enables capture of an image of the top surface of the print media as it passes through the printer. The scanner can analyze for and detect any missing jets or defects in the printing system, including print head stitching errors or a density differential. By comparing a target print image density with the actual measurement results and evaluating criteria such as uniformity, coverage, and defects, the inline scanner helps identify areas where adjustments to print head jetting conditions can be approved.

In examples, detecting a stich zone differential between multiple print heads in a full width array in an ink jet printing system can include visual inspection of the printed media, and can be accomplished by viewing diagnostic prints through a color filter or alternate light source. In examples, the inspection can be done with the naked eye for black, cyan and magenta. A filter or alternate light might be needed for yellow and precoat or other less visible or lower contrast materials. This approach helps to enhance or further reveal any areas where print density variations exist, allowing for identification of potential jetting issues. The use of a color filter or light source can also be useful when working with different types or colors of inks, as it allows for better visualization of any discrepancies between the expected and actual results. The specific type of filter or light source used may depend on factors such as the type of ink being employed and the desired level of contrast for better visualization. Color filtering may be used to drop out the background color thus enhancing the contrast of the printed features or images being detected.

A typical inkjet printer uses one or more printheads. Each printhead typically contains an array of individual nozzles, or jets, for ejecting drops of ink across an open gap to an image receiving member to form an image. In examples of the present disclosure, multiple print heads can be assembled into an array to print a single color across an entire width of the print media or image receiving member. The image receiving member may be a continuous web of recording media, a series of media sheets, or the image receiving member may be a rotating surface, such as a print drum or endless belt. Images printed on a rotating surface are later transferred to recording media by mechanical force in a transfix nip formed by the rotating surface and a transfix roller. In an inkjet printhead, individual piezoelectric, thermal, or acoustic actuators generate mechanical forces that expel ink through an orifice from an ink filled conduit in response to an electrical voltage signal, sometimes called a firing signal. The magnitude, or voltage level, of the signals affects the amount of ink ejected in each drop. The firing signal is generated by a printhead controller in accordance with image data. An inkjet printer forms a printed image in accordance with the image data by printing a pattern of individual ink drops at particular locations on the image receiving member. The locations where the ink drops landed are sometimes called “ink drop locations,” “ink drop positions,” or “pixels.” Thus, a printing operation can be viewed as the placement of ink drops on an image receiving member in accordance with image data.

In order for the printed images to correspond closely to the image data, both in terms of fidelity to the image objects and the colors represented by the image data, the printheads must be registered with reference to the imaging surface and with the other printheads in the printer, and more particularly in the same print head array. Registration of printheads is a process in which the printheads are operated to eject ink in a known pattern and then the printed image of the ejected ink is analyzed to determine the orientation of the printhead with reference to the imaging surface and with reference to the other printheads in the printer. Operating the printheads in a printer to eject ink in correspondence with image data presumes that the printheads are level with a width across the image receiving member and that all of the inkjet ejectors in the printhead are operational. The presumptions regarding the orientations of the printheads, however, cannot be assumed, but must be verified. Additionally, if the conditions for proper operation of the printheads cannot be verified, the analysis of the printed image should generate data that can be used either to adjust the printheads so they better conform to the presumed conditions for printing or to compensate for the deviations of the printheads from the presumed conditions. It should be noted that when added to an inkjet printing system, a printhead used for the purpose of dispensing or ejecting primer follows these same principles of operation and maintains many of the same requirements, save for standard adjustments also applicable to the general printing of inks within such systems.

Analysis of printed images is performed with reference to two directions. “Process direction” refers to the direction in which the image receiving member is moving as the imaging surface passes the printhead to receive the ejected ink and “cross-process direction” refers to the direction across the width of the image receiving member or media. In order to analyze a printed image, a test pattern needs to be generated so determinations can be made as to whether the inkjets operated to eject ink did, in fact, eject ink and whether the ejected ink landed where the ink would have landed if the printhead was oriented correctly with reference to the image receiving member and the other printheads in the printer. In some printing systems, an image of a printed image is generated by printing the printed image onto media or by transferring the printed image onto media, ejecting the media from the system, and then scanning the image with a flatbed scanner or other known offline imaging device. This method of generating a picture of the printed image suffers from the inability to analysis the printed image in situ and from the inaccuracies imposed by the external scanner. In some printers, a scanner is integrated into the printer and positioned at a location in the printer that enables an image of an ink image to be generated while the image is on media within the printer or while the ink image is on the rotating image member. These integrated scanners typically include one or more illumination sources and a plurality of optical detectors that receive radiation from the illumination source that has been reflected from the image receiving surface. The radiation from the illumination source is usually visible light, but the radiation may be at or beyond either end of the visible light spectrum. If light is reflected by a white surface, the reflected light has the same spectrum as the illuminating light. In some systems, ink on the imaging surface may absorb a portion of the incident light, which causes the reflected light to have a different spectrum. In addition, some inks may emit radiation in a different wavelength than the illuminating radiation, such as when an ink fluoresces in response to a stimulating radiation. Each optical sensor generates an electrical signal that corresponds to the intensity of the reflected light received by the detector. The electrical signals from the optical detectors may be converted to digital signals by analog/digital converters and provided as digital image data to an image processor.

The ability to differentiate features of different ink colors is subject to the phenomenon of missing or weak inkjet ejectors. Weak inkjet ejectors are ejectors that do not respond to a firing signal by ejecting an amount of ink that corresponds to the amplitude or frequency of the firing signal delivered to the inkjet ejector. A weak inkjet ejector, instead, delivers a lesser amount of ink. Consequently, the lesser amount of ink or other liquids ejected by a weak jet covers less of the image receiving member so the contrast of the signal generated by the optical detector with reference to an uncovered portion of the image receiving member is lower. Therefore, ink drops in a feature or image ejected by a weak inkjet ejector may result in an electrical signal having a magnitude that is different than that expected. Missing inkjet ejectors are inkjet ejectors that eject little or no ink in response to the delivery of a firing signal. A process for identifying the inkjet ejectors that fail to eject ink drops or primer for such test patterns is discussed in more detail below can be found in U.S. Pat. No. 8,721,033, which is incorporated by reference herein. These concepts and methods can be applied to detecting and diagnosing issues in stitching differentials of ejection when viewed across or at a mating edge of multiple print heads in a full width array as described herein.

The printing system for minimizing stitch zone differentials between adjacent print heads in a production ink jet printer, in examples, can include at least three print heads arranged in an array configured to print aqueous ink in an interlaced manner and form a single pass of printed image, a scanner configured for measuring an average print density of each print head near a stitching area of each print head, and a non-transitory storage media configured to execute an algorithm that adjusts drive voltages based on measurements of the scanner to minimize stitch zone differentials between adjacent print heads. The printing system also includes a sensor, or a sensor array, i.e. multiple networked or interconnected individual sensors, configured to monitor print density and wherein adjusting drive voltages occurs prior to jetting ink from one of the print heads. The printing system for minimizing stitch zone differentials between adjacent print heads in a production ink jet printer includes an algorithm that is configured to adjust drive voltages based on a statistical distribution of measured print density of one or more printed test patches.

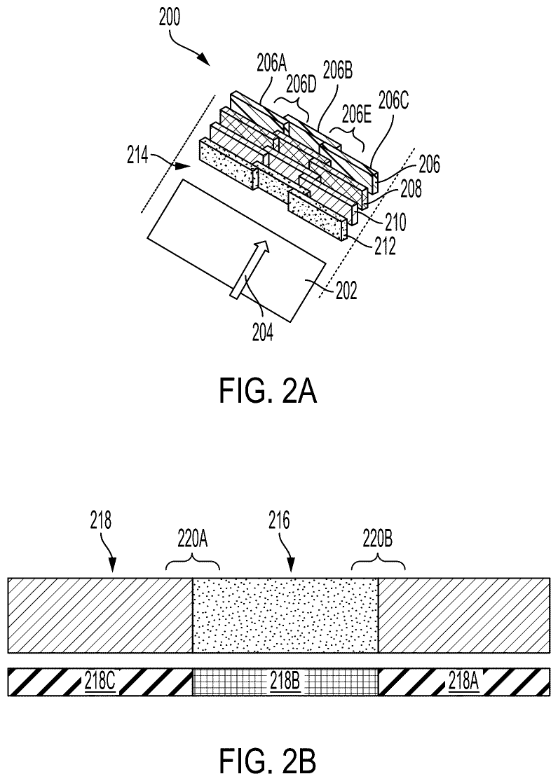

FIGS. 2A and 2B are a schematic of a print head array layout with a stitch zone, and a top view of a printed patch from a similar print head array, in accordance with the present disclosure. A print head array layout 200 is shown in FIG. 2A, with media 202 shown passing below a set of full-width print head arrays in a process direction 204 along a media path 214. A first print head array 206, a second print head array 208, a third print head array 210, and a fourth print head array 212 are shown. The first print head array 206 includes a first print head 206A, a second print head 206B, and a third print head 206C. The remaining print head arrays 208, 210, 212 each include three print heads each, but they are not specifically addressed for the purposes of clarity. Between the first print head 206A and the second print head 206B is an overlapping first print head mating zone 206D, while between the second print head 206B and the third print head 206C is an overlapping second print head mating zone 206E. In examples, production ink jet printers interlace (stitch) multiple print heads together to enable printing of wide paper in one pass. In examples, a system might use three print heads per color to achieve a print width of 14 inches. While print heads are calibrated during manufacturing to a drop mass target, there is enough print head to print head variation to visually see a difference in image density in the production printer in examples. As shown in FIG. 2B, a top view of a printed patch 216, is shown with a test print 218, with the test print 218 corresponding to a location of a first print head 218A, a second print head 218B, and a third print head 218C that make up a print head array. Indicated are also locations for a first mating edge 220A and a second mating edge 220B on the print.

Methods exist to adjust the average print density of each print head (as noted in U.S. Pat. No. 7,585,044 Method For Normalizing a Printhead Assembly, which is hereby incorporated by reference in its entirety herein). This normalization removes most of the print head to print head variation, however, when a density variation exists within a single print head, the edge of one print head may have a different density than the edge of the neighboring print head. This causes a sudden shift of print density in the print which is more visible than a gradual shift in print density of the same magnitude within one or more mating edges or mating edge zones. A density optimization algorithm can be used to smooth density variations, however, the sudden change in the stitch zone region is sometimes too large for complete compensation. Density optimization is a setup routine that measures the cross-process density uniformity of a single print bar or array. It creates a compensation profile that will add or subtract pixels to each printed image to compensate for consistent localized light or dark areas. Head level norming can be thought of as a gross adjustment at the print head level, while density optimization is the fine adjustment at the jet level.

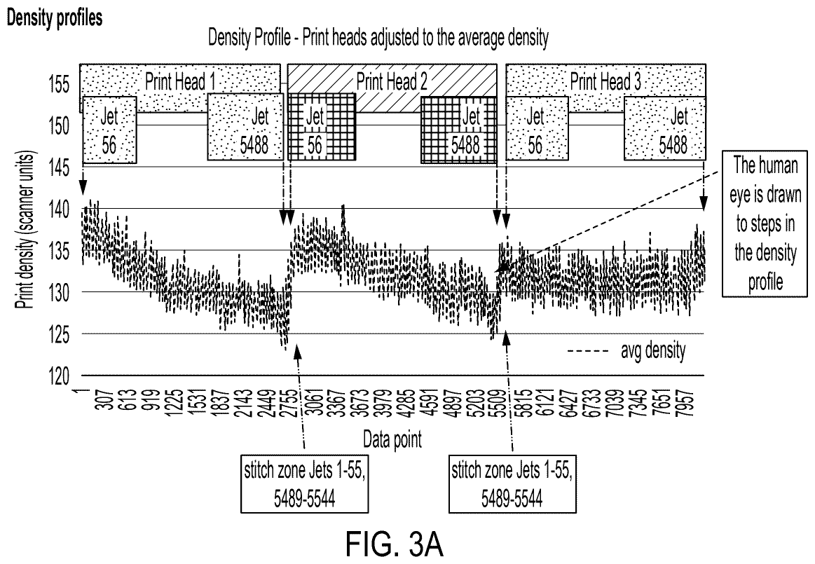

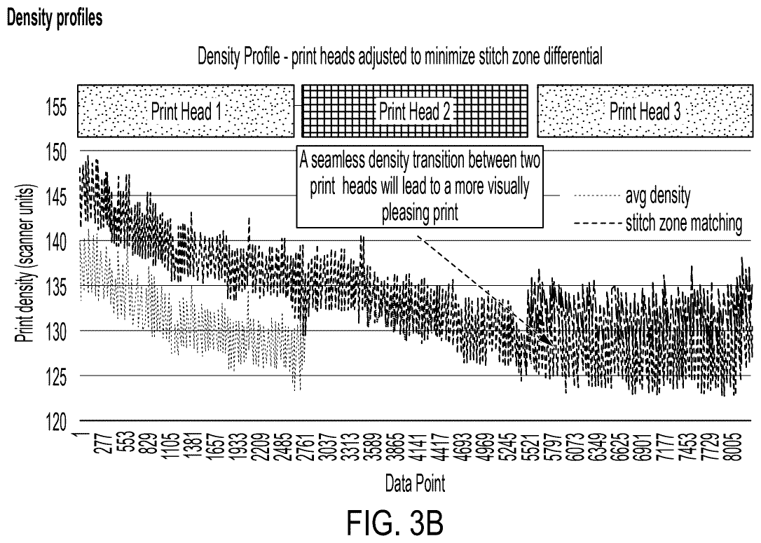

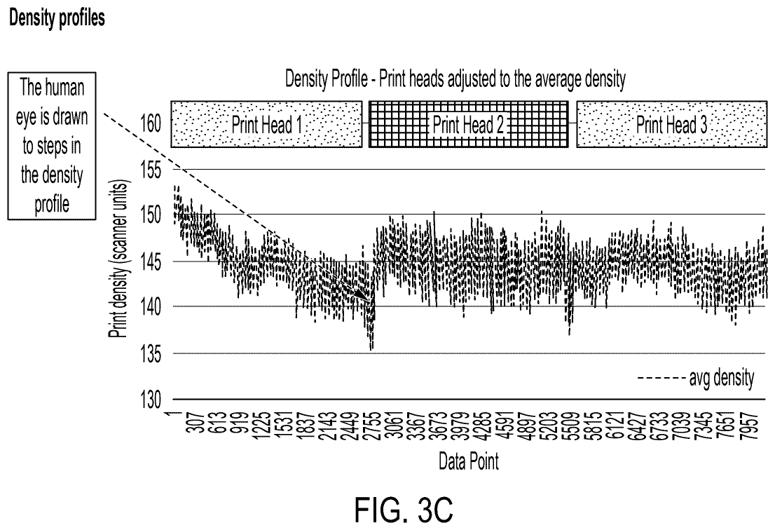

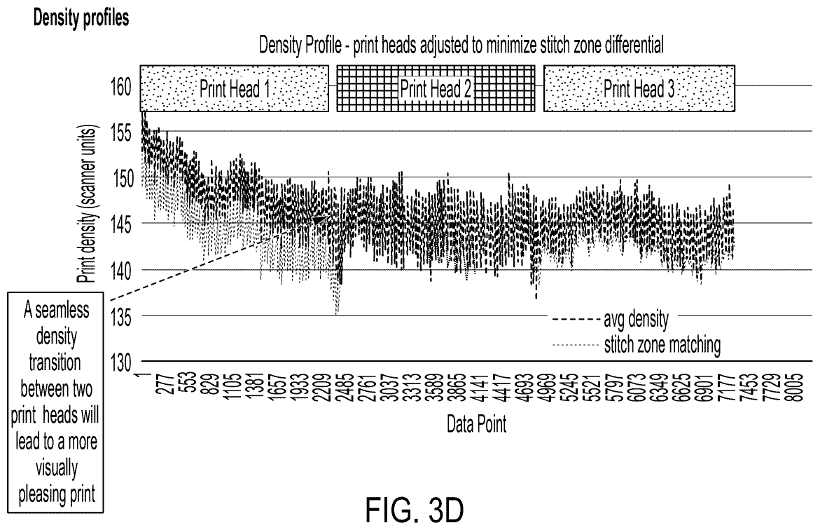

FIGS. 3A-3D are plots demonstrating the results of a method for minimizing printhead density differences in a printing system, in accordance with the present disclosure. Two examples of head uniformities. Improved blending of print density in the stitch/interlace areas where two print heads meet or mate in a production ink jet system is shown. This procedure can reduce the amount of adjustment required during density optimization.

Shown in FIGS. 3A and 3C, respectively are two different examples of head uniformities after the average density has been adjusted. Since the uniformities have a visible slope, the mating edges of the heads end up having a differential in density, such that adjustment is needed to smooth or reduce the stitching zone appearance. The plots of FIGS. 3B and 3D, respectively, show an average density, which corresponds to the plot above, with the stitch zone matching line corresponding to a post-adjusted print density at the edges of each print head in order to remove the edge differential. While the image may still exhibit some changes in the absolute density across the print head array, they are less noticeable because of the smoothing resulting from the modification of the voltage of the print head operation.

The head norming algorithm results in a changing of each print head voltage to match the edge of the second, or central print head one by moving the head voltage up or down to match the edge of the adjacent print head. Without being bound by any particular theory, it is understood that visual differences are perceptible if an image or print density is different by enough magnitude over a short enough distance. The present disclosure provides a method where the overall voltage of a print head is moved or adjusted to match the average density, or to change the image density to flatten the profile as shown in FIGS. 3A-3D. The driving of the average voltage is targeted to match the edges, even if the overall average of the heads is not exactly the same, but so long as the print density matches in the stitch zone. This can show the resulting print density gradient over a sixteenth of an inch, an eighth of an inch, a quart of an inch, or an inch or over several inches.

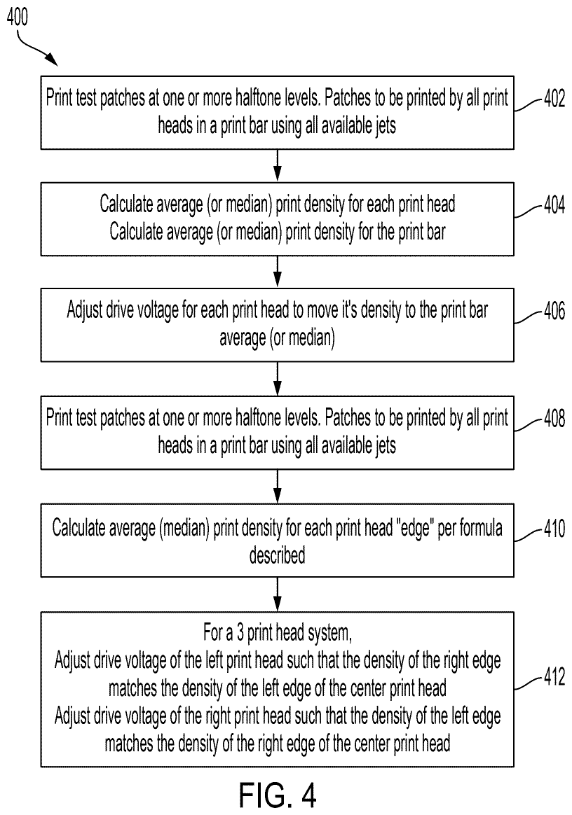

FIG. 4 is a flowchart illustrating a method for minimizing printhead density differences in a printing system, in accordance with the present disclosure. The method for minimizing printhead density differences 400 includes the steps of printing a first test patch onto a first print at one or more halftone levels using a print head array comprising more than one print head 402, scanning the first test patch, calculating an average print density of the first test patch for each print head and an average print density for the print head array 404, adjusting a drive voltage for each print head to match the average print density of the first test patch for the print head array 406, printing a second test patch onto a second print at one or more halftone levels using the print head array 408, scanning the second test patch, and calculating an average print density of the second test patch for each print head and an average print density for the print head array 410, and wherein the first test patch and the second test patch are printed by all print heads in the print head array. In examples, the average print density of the first test patch and the second test patch are calculated at an edge of each print head or in a mating zone or mating edge area between two print heads. In examples, the method 400 includes adjusting a drive voltage for each print head to match the average print density of the second test patch for the print head array, or where the one or more halftone levels for the first test patch and the second test patch are printed with black pigmented ink or a common pigmented ink. The process is done independently for each color station. Cyan, magenta, yellow and black as well as any other ink color that may be loaded in the printer. Examples include where printing the first test patch and printing the second test patch is done using all available jets in the print head array, or where the print head array comprises three print heads. Printing systems typically have three print heads in an array, but it is conceivable to only have two print heads or to have more than three. It is unlikely to have more than five to seven printheads in an array.

In examples, adjusting a drive voltage for each print head further includes adjusting a drive voltage of a left print head such that a density of a right edge of the left print head matches a left edge of a center print head, and adjusting a drive voltage of a right print head such that a density of a left edge of the left print head matches a right edge of the center print head 412. An inner edge can have the same average density as the mating edge of the center print head. In examples of the method 400, the method can include repeating the adjustment of a drive voltage for each print head until a difference between an edge of each print head is visually imperceptible. For cases where there are not three print heads, the same process can be used, starting with the center head and working outward. For even numbers of print heads, either of the two center heads can be selected.

Another example of a method for minimizing stitch zone differential between adjacent print heads in a production ink jet system, can include printing a first test patch onto a first print at one or more halftone levels using a print head array comprising a first print head and a second print head, scanning the first test patch, calculating an average density of jets near a mating edge of the first print head and a mating edge of the second print head, and adjusting a drive voltage for the first print head to move an average print density of the first print head at the mating edge of the first print head towards an average print density of the mating edge of the second print head. Examples can include where the print head array further includes a third print head, or where the method further includes the steps of printing the first test patch using the third print head, calculating an average density of jets near a mating edge of the third print head and a second mating edge of the second print head, and adjusting a drive voltage for the third print head to move the average print density of the third print head at the mating edge of the third print head towards an average print density of the second mating edge of the second print head. The execution of a print density optimization algorithm can be used to reduce remaining density variations across an entire process width of the print head array. Also, adjustment of drive voltages can be repeated iteratively until a difference between the average print density of the first print head at the mating edge of the first print head and an average print density of the mating edge of the second print head is visually imperceptible. Furthermore, adjusting the drive voltage can be made based on paper type or printing conditions, or other factors as described herein. It should be noted that in some examples, black pigmented ink or a common pigmented ink can be used in printing test patches, as well as other colors as needed. Each single separation is processed independently. For example cyan, magenta, yellow, and black (C, M, Y & K). There may be little value in measuring a process black.

The head-to-head norming algorithm adjustment for average print density can ensure that all printheads have an equal starting point before further adjustments by calibrating their drive voltages based on a target drop mass Drop mass is only measured/adjusted in the print head manufacturing process as it involves weighing the ejected ink. Calibration values stored in the print head from the factory drop mass calibration. The process described herein starts with those calibrated values. This process involves measuring the average density of each printhead and adjusting its voltage levels to match those of other heads, thereby minimizing stitch zone differentials between adjacent printheads. In one example, this algorithm may be implemented using statistical methods such as least squares optimization or gradient descent techniques like steepest decent or conjugate gradient. For example, a sample implementation might involve calculating the average density of jets 5279 to 5479 from a center print head and adjusting its drive voltage levels by an amount useful to move this value closer to that of neighboring printheads on either side. Furthermore, when the print heads are manufactured, they are calibrated and the drive voltage that they need to run at is noted during fabrication/manufacturing of the print head, which serves as a starting point for a drive voltage setting.

The adjustment step may involve adjusting voltage levels gradually over time to avoid sudden changes that might affect overall printer stability. Additionally, some examples might use signal processing methods like filtering or interpolation for further refining density calculations based on neighboring jet data. The algorithm may also be optimized by incorporating paper-specific settings and learning patterns between print quality, paper type (e.g., glossy vs matte), and adjusting drive voltages accordingly.

In another example, the head-to-head norming or normalization process may involve multiple iterations of adjustment until convergence or within a specified tolerance. This iterative approach ensures that even small variations in density are accounted for during calibration. The algorithm may also be integrated with other quality improvement methods like color correction techniques to achieve optimal print results by combining both algorithms.

The adjustment process to match inner edge with mating edge, between a central print head and one or more of the neighboring print heads, involves a series of steps that ensure seamless blending in the stitch zone area by calibrating drive voltages based on measured density values from specific jet ranges within each head. In one example, this is achieved through an iterative algorithmic approach where the central print head (also referred to as print head 2 or the second print head) serves as a reference point for adjusting voltage levels of adjacent heads (also referred to as print head 1 and/or print head 3, or alternatively, the first print head and/or the third print head). The process begins with the calculation of average densities using jets 5279-5479 from print head 1 and jets 65-265 from print head 2. This range selection is deliberate, avoiding edge effects by focusing on central regions within each print head.

In another example, a statistical approach may be employed to monitor density values for anomalies or outliers during this step, allowing the algorithm to adjust drive voltages accordingly based on calculated densities rather than relying solely on raw data points. Furthermore, signal processing techniques like filtering and interpolation may also be applied to refine calculations by incorporating neighboring jet information. In a more complex example involving multiple iterations, the adjustment process may involve adjusting drive voltages based on calculated average densities from each head until convergence is achieved or within specified tolerance limits (e.g., ±0.5%). This iterative approach ensures optimal blending in stitch zone areas while maintaining stable printing quality across different paper types and environmental conditions.

In addition, the present algorithm may be optimized by incorporating paper type-specific settings that learn patterns between print quality, paper characteristics (e.g., glossy vs matte), and adjust drive voltages accordingly. This may involve weighted averaging schemes during density calculations to account for differences in nozzle-to-nozzle variation among various printhead designs or adjusting localized areas within each head based on specific printing conditions. By combining these techniques with the existing density optimization algorithm, seamless blending of print densities across adjacent heads can be achieved while maintaining overall printing quality.

A second calculation step involves a similar process to Step 1 and 2, where drive voltages of print head 3 are adjusted based on the calculated average density values from jets 65-265. This ensures that the inner edge of print head 3 has an identical print density profile compared to its mating edge with neighboring heads. To achieve this, a sample algorithm calculates the average density value for jets 5279-5479 in print head 2 and compares it to the corresponding range (jets 65-265) from print head 3. The drive voltages of print head 3 are then adjusted by an amount useful to align its inner edge with the mating edge's print density profile, thereby minimizing stitch zone differentials. In some cases, the algorithm may use more complex averaging schemes by incorporating multiple iterations of Step 2 until convergence is achieved within a specified tolerance.

In addition to these optimization methods, the density optimization algorithm may also incorporate various techniques for handling specific scenarios. For instance, in cases where a single print head exhibits density variations within its own region (e.g., jets 65-265), localized adjustments may be made by adjusting drive voltages only for those affected areas. In situations involving multiple heads with similar average densities but still exhibiting noticeable differences between adjacent edges, the algorithm may employ weighted averaging schemes during calculations to account for nozzle-to-nozzle variation among different printhead designs. Furthermore, this optimization process is not limited solely to adjustments within a single print head. It may also be applied across entire color stations or even multiple heads in tandem by incorporating additional parameters such as weighting factors based on the relative importance of each region's density values, adjustments made separately per-color station if necessary. By integrating these various optimization techniques and examples, this solution provides a robust framework for minimizing stitch zone differentials while maintaining overall printing quality across diverse paper types, environmental conditions, or printhead designs.

The final adjustment step involves image based corrections based on density optimization results to ensure seamless blending across the entire image based on calculated average densities from specific jet ranges and weighted averaging schemes applied during density calculations.

In various embodiments, a hardware configuration may include the computer readable medium which can be used to perform one or more of the processes described above. The hardware configuration may include any type of mobile devices, such as smart telephones, laptop computers, tablet computers, cellular telephones, personal digital assistants, etc. Further the hardware configuration can include one or more processors of varying core configurations and clock frequencies. The hardware configuration may also include one or more memory devices that serve as a main memory during operations, calculations, or simulations as described herein. For example, during operation, a copy of the software that supports the above-described operations can be stored in one or more memory devices. One or more peripheral interfaces, such as keyboards, mice, touchpads, computer screens, touchscreens, etc., for enabling human interaction with and manipulation of the hardware configuration may also be included. Exemplary hardware configurations can also include a data bus, one or more storage devices of varying physical dimensions and storage capacities, such as flash drives, hard drives, random access memory, etc., for storing data, such as images, files, and program instructions for execution by the one or more processors. One or more network interfaces for communicating via one or more networks, such as Ethernet adapters, wireless transceivers, or serial network components, for communicating over wired or wireless media using protocols may further be included.

Additionally, hardware configurations in certain embodiments can include one or more software programs that enable the functionality described herein. The one or more software programs can include instructions that cause the one or more processors to perform the processes, functions, and operations described herein related to calculations, inputs, simulations, pulsed waveform generation, and combinations thereof. Copies of the one or more software programs can be stored in the one or more memory devices and/or on in the one or more storage devices. Likewise, the data utilized by one or more software programs can be stored in the one or more memory devices and/or on in the one or more storage devices.

If implemented in software, the functions can be stored on or transmitted over a computer-readable medium as one or more instructions or code. Computer-readable media includes both tangible, non-transitory computer storage media and communication media including any medium that facilitates transfer of a computer program from one place to another. A storage media can be any available tangible, non-transitory media that can be accessed by a computer. By way of example, and not limitation, such tangible, non-transitory computer-readable media can comprise RAM, ROM, flash memory, or EEPROM. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Combinations of the above should also be included within the scope of computer-readable media.

In one or more exemplary embodiments, the functions described can be implemented in hardware, software, firmware, or any combination thereof. For a software implementation, the techniques described herein can be implemented with modules (e.g., procedures, functions, subprograms, programs, routines, subroutines, modules, software packages, classes, and so on) that perform the functions described herein. A module can be coupled to another module or a hardware circuit by passing and/or receiving information, data, arguments, parameters, or memory contents. Information, arguments, parameters, data, or the like can be passed, forwarded, or transmitted using any suitable means including memory sharing, message passing, token passing, network transmission, and the like. The software codes can be stored in memory units and executed by processors. The memory unit can be implemented within the processor or external to the processor, in which case it can be communicatively coupled to the processor via various means as is known in the art.

In one or more exemplary embodiments, the functions described can be implemented in hardware, software, firmware, or any combination thereof. For a software implementation, the techniques described herein can be implemented with modules (e.g., procedures, functions, subprograms, programs, routines, subroutines, modules, software packages, classes, and so on) that perform the functions described herein. A module can be coupled to another module or a hardware circuit by passing and/or receiving information, data, arguments, parameters, or memory contents. Information, arguments, parameters, data, or the like can be passed, forwarded, or transmitted using any suitable means including memory sharing, message passing, token passing, network transmission, and the like. The software codes can be stored in memory units and executed by processors. The memory unit can be implemented within the processor or external to the processor, in which case it can be communicatively coupled to the processor via various means as is known in the art.

In other embodiments, a non-transitory computer-readable medium may include instructions, that when executed by a hardware processor, causes the hardware processor to perform operations to execute an algorithm that adjusts drive voltages based on measurements of the scanner to minimize stitch zone differentials between adjacent print heads. This method or system may include a sensor array configured to monitor print density during printing and wherein adjusting drive voltages occurs at substantially the same time as jetting ink from one of the print heads, or wherein the algorithm adjusts drive voltages based on a statistical distribution of measured print density, with or without interfacing and receiving information from or transmitting information to the sensor array or other controllers or storage media within the printing system.

While the present teachings have been illustrated with respect to one or more implementations, alterations and/or modifications may be made to the illustrated examples without departing from the spirit and scope of the appended claims. For example, it may be appreciated that while the process is described as a series of acts or events, the present teachings are not limited by the ordering of such acts or events. Some acts may occur in different orders and/or concurrently with other acts or events apart from those described herein. Also, not all process stages may be required to implement a methodology in accordance with one or more aspects or embodiments of the present teachings. It may be appreciated that structural objects and/or processing stages may be added, or existing structural objects and/or processing stages may be removed or modified. Further, one or more of the acts depicted herein may be carried out in one or more separate acts and/or phases. Furthermore, to the extent that the terms “including,” “includes,” “having,” “has,” “with,” or variants thereof are used in either the detailed description and the claims, such terms are intended to be inclusive in a manner similar to the term “comprising.” The term “at least one of” is used to mean one or more of the listed items may be selected. Further, in the discussion and claims herein, the term “on” used with respect to two materials, one “on” the other, means at least some contact between the materials, while “over” means the materials are in proximity, but possibly with one or more additional intervening materials such that contact is possible but not required. Neither “on” nor “over” implies any directionality as used herein. The term “conformal” describes a coating material in which angles of the underlying material are preserved by the conformal material. The term “about” indicates that the value listed may be somewhat altered, as long as the alteration does not result in nonconformance of the process or structure to the illustrated embodiment. The terms “couple,” “coupled,” “connect,” “connection,” “connected,” “in connection with,” and “connecting” refer to “in direct connection with” or “in connection with via one or more intermediate elements or members.” Finally, the terms “exemplary” or “illustrative” indicate the description is used as an example, rather than implying that it is an ideal. Other embodiments of the present teachings may be apparent to those skilled in the art from consideration of the specification and practice of the disclosure herein. It is intended that the specification and examples be considered as exemplary only, with a true scope and spirit of the present teachings being indicated by the following claims.

What is claimed is:

1. A method for minimizing printhead density differences, comprising:
printing a first test patch onto a first print at one or more halftone levels using a print head array comprising more than one print head;
scanning the first test patch;
calculating an average print density of the first test patch for each print head and an average print density for the print head array;
adjusting a drive voltage for each print head to match the average print density of the first test patch for the print head array;
printing a second test patch onto a second print at one or more halftone levels using the print head array;
scanning the second test patch; and
calculating an average print density of the second test patch for each print head and an average print density for the print head array; and wherein:
the first test patch and the second test patch are printed by all print heads in the print head array.

2. The method for minimizing printhead density differences of claim 1, wherein the average print density of the first test patch and the second test patch are calculated at an edge of each print head.

3. The method for minimizing printhead density differences of claim 1, further comprising adjusting a drive voltage for each print head to match the average print density of the second test patch for the print head array.

4. The method for minimizing printhead density differences of claim 1, wherein the one or more halftone levels for the first test patch and the second test patch are printed with a common pigmented ink.

5. The method for minimizing printhead density differences of claim 1, wherein printing the first test patch and printing the second test patch is done using all available jets in the print head array.

6. The method for minimizing printhead density differences of claim 1, wherein the print head array comprises three print heads.

7. The method for minimizing printhead density differences of claim 6, wherein adjusting a drive voltage for each print head further comprises:
adjusting a drive voltage of a left print head such that a density of a right edge of the left print head matches a left edge of a neighboring print head; and
adjusting a drive voltage of a right print head such that a density of a left edge of the left print head matches a right edge of the neighboring print head.

8. The method for minimizing printhead density differences of claim 7, wherein an inner edge has the same average density as the mating edge of the neighboring print head.

9. The method for minimizing printhead density differences of claim 1, further comprising repeating adjusting a drive voltage for each print head until a difference between an edge of each print head is visually imperceptible.

10. A method for minimizing stitch zone differential between adjacent print heads in a production ink jet system, comprising:
printing a first test patch onto a first print at one or more halftone levels using a print head array comprising a first print head and a second print head;
scanning the first test patch;
calculating an average density of jets near a mating edge of the first print head and a mating edge of the second print head; and
adjusting a drive voltage for the first print head to move an average print density of the first print head at the mating edge of the first print head towards an average print density of the mating edge of the second print head.

11. The method for minimizing stitch zone differential between adjacent print heads in a production ink jet system of claim 10, wherein the print head array further comprises a third print head.

12. The method for minimizing stitch zone differential between adjacent print heads in a production ink jet system of claim 11, further comprising:
printing the first test patch using the third print head;
calculating an average density of jets near a mating edge of the third print head and a second mating edge of the second print head; and
adjusting a drive voltage for the third print head to move the average print density of the third print head at the mating edge of the third print head towards an average print density of the second mating edge of the second print head.

13. The method for minimizing stitch zone differential between adjacent print heads in a production ink jet system of claim 10, further comprising executing a print density optimization algorithm to reduce remaining density variations across an entire process width of the print head array.

14. The method for minimizing stitch zone differential between adjacent print heads in a production ink jet system of claim 10, further comprising repeating adjusting drive voltages until a difference between the average print density of the first print head at the mating edge of the first print head and an average print density of the mating edge of the second print head is visually imperceptible.

15. The method for minimizing stitch zone differential between adjacent print heads in a production ink jet system of claim 10, where the adjusting the drive voltage is made based on paper type or printing conditions.

16. The method for minimizing stitch zone differential between adjacent print heads in a production ink jet system of claim 10, wherein the one or more halftone levels for the first test patch is printed with black pigmented ink.

17. The method for minimizing stitch zone differential between adjacent print heads in a production ink jet system of claim 10, wherein the one or more halftone levels for the first test patch is printed with a color other than black pigmented ink.

18. A printing system for minimizing stitch zone differentials between adjacent print heads in a production ink jet printer, comprising:
at least three print heads arranged in an array configured to print aqueous ink in an interlaced manner and form a single pass of printed image;
a scanner configured for measuring an average print density of each print head near a stitching area of each print head; and
a non-transitory storage media configured to execute an algorithm that adjusts drive voltages based on measurements of the scanner to minimize stitch zone differentials between adjacent print heads.

19. The printing system for minimizing stitch zone differentials between adjacent print heads in a production ink jet printer of claim 18, further comprising a sensor array configured to monitor print density during printing and wherein adjusting drive voltages occurs prior to jetting ink from one of the print heads.

20. The printing system for minimizing stitch zone differentials between adjacent print heads in a production ink jet printer of claim 18, wherein the algorithm adjusts drive voltages based on a statistical distribution of measured print density.
